(19) United States
(12) Patent Application Publication
(10) Pub. No.: US 2024/0047125 A1
(43) Pub. Date: Feb. 8, 2024

(54) INDUCTIVE APPARATUS WITH HELICAL COIL FRAME

(71) Applicant: Eaton Intelligent Power Limited, Dublin (IE)

(72) Inventors: Geraldo Nojima, Fort Mill, SC (US); Eddie Wilkie, Fletcher, NC (US)

(21) Appl. No.: 17/883,417

(22) Filed: Aug. 8, 2022

(51) Int. Cl. H01F 27/30; H01F 27/28; H01F 27/24

(52) U.S. Cl. CPC H01F 27/306; H01F 27/2823; H01F 27/24

(57) ABSTRACT

An apparatus includes a core and a helical frame coaxial with a segment of the core and having first and second major surfaces on opposite sides of the helical frame and each normal to a surface of the segment. At least one helical coil conforms to at least one of the first and second major surfaces. In some embodiments, the at least one helical coil may include first and second helical coils conforming to respective ones of the first and second major surfaces.

### BACKGROUND

The inventive subject matter relates to passive circuit components and, more particularly, to inductive devices.

Power conversion circuits for applications such as power supplies, solid-state transformers and motor drives typically include inductive components such as transformers and various types of inductors. With the increasing use of high-voltage power switching devices, such as silicon carbide (SiC) based transistors, in power conversion circuits, increased demands are placed on such components. In particular, these components need to operate reliably under dramatically increased voltage gradients, amplitudes, and switching frequencies while utilizing space-efficient designs with adequate cooling and desirably low levels of unwanted parasitic effects. Accordingly, there is a need for compact inductive components that can withstand high voltages without arcing or dielectric breakdowns while operating effectively at high frequencies.

### SUMMARY

Some embodiments provide an apparatus including a core and a helical frame coaxial with a segment of the core and having first and second major surfaces on opposite sides of the helical frame and each normal to a surface of the segment. At least one helical coil conforms to at least one of the first and second major surfaces. In some embodiments, the at least one helical coil may include a helical ribbon conductor having a major surface disposed parallel to one of the first and second major surfaces. In some embodiments, the at least one helical coil may include a plurality of concentric helical coils disposed parallel to one of the first and second major surfaces. The concentric helical coils may include concentric ribbon conductors having major surfaces arrayed in a plane normal to the one of the first and second major surfaces.

According to further embodiments, the at least one helical coil may include first and second helical coils conforming to respective ones of the first and second major surfaces. The first helical coil may include a helical ribbon conductor having a major surface disposed parallel to the first major surface of the helical frame. The second helical coil may include a plurality of concentric helical coils arrayed parallel to the second major surface of the helical frame.

According to further aspects, the helical frame may include a plurality of interconnected modular segments. The segment of the core may be linear.

Still further embodiments provide an apparatus including a toroidal core comprising a linear segment. A helical frame is coaxial with the linear segment and has first and second major surfaces on opposite sides of the helical frame and each normal to a surface of the linear segment of the toroidal core. First and second helical coils conform to respective ones of the first and second major surfaces of the helical frame.

Additional embodiments provide a transformer including a core comprising a linear segment and a helical frame coaxial with the linear segment and having first and second major surfaces on opposite sides of the helical frame and each normal to the linear segment. The transformer further includes a first helical coil conforming to the first major surface and a second helical coil conforming to the second major surface. The transformer may further include an enclosure containing the core, the helical frame and the first and second helical coils therein and a conduit disposed in the enclosure, surrounding the core, the helical frame and the first and second helical coils, and configured to circulate a cooling fluid.

### BRIEF DESCRIPTION OF THE DRAWINGS

FIG. 1 is a perspective view of a transformer according to some embodiments of the inventive subject matter.

FIG. 2 is another perspective view of the transformer of FIG. 1.

FIG. 3 is a detailed perspective view of the transformer of FIG. 1.

FIG. 4 is another detailed perspective view of the transformer of FIG. 1.

FIG. 5 is a perspective view of a helical coil frame of the transformer of FIG. 1.

FIG. 6 is a detailed perspective view of the helical coil frame of the transformer of FIG. 1.

FIG. 7 is another perspective view of the helical coil frame of the transformer of FIG. 1.

FIG. 8 is a perspective view of a section of a first coil of the transformer of FIG. 1.

FIG. 9. is a perspective view of second of a second coil of the transformer of FIG. 1.

FIG. 10 is a perspective view of an enclosed version of the transformer of FIG. 1 according to some embodiments.

FIG. 11 is a perspective view of the enclosure transformer of FIG. 10 with a top cover removed to show the transformer of FIG. 1.

FIG. 12 is a perspective view of the enclosed transformer of FIG. 10 with the enclosure removed to show a cooling conduit coil according to some embodiments.

FIG. 13 is a cross-section view corresponding to the perspective view of FIG. 12.

FIG. 14 is a perspective view of an enclosed transformer with cooling conduits according to further embodiments.

### DETAILED DESCRIPTION

The inventive concept will be described more fully hereinafter with reference to the accompanying figures, in which embodiments of the inventive concept are shown. This inventive concept may, however, be embodied in many alternate forms and should not be construed as limited to the embodiments set forth herein.

Accordingly, while the inventive concept is susceptible to various modifications and alternative forms, specific embodiments thereof are shown by way of example in the drawings and will herein be described in detail. It should be understood, however, that there is no intent to limit the inventive concept to the particular forms disclosed, but on the contrary, the inventive concept is to cover all modifications, equivalents, and alternatives falling within the spirit and scope of the inventive concept as defined by the claims. Like numbers refer to like elements throughout the description of the figures.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises,” “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this inventive concept belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

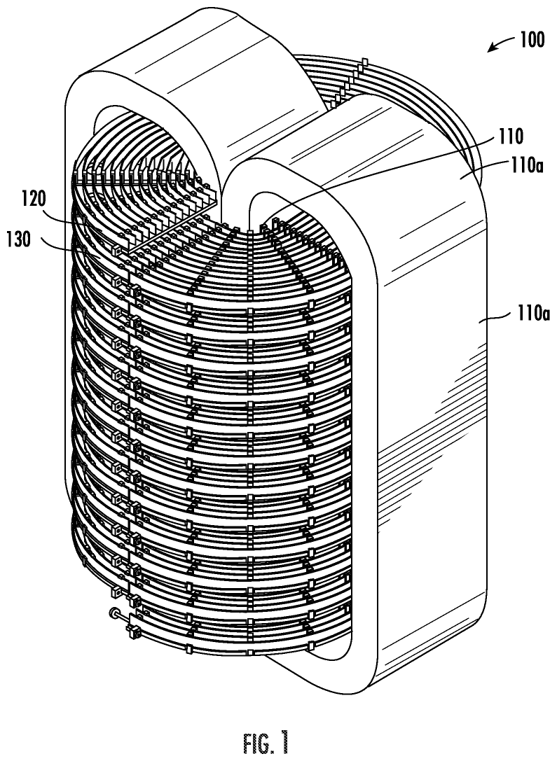

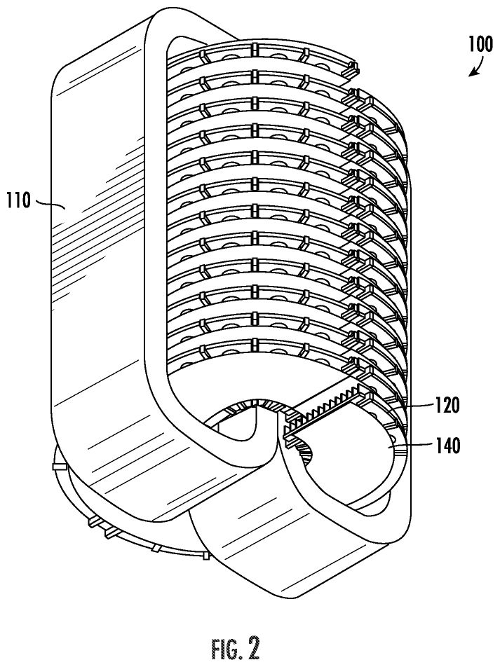

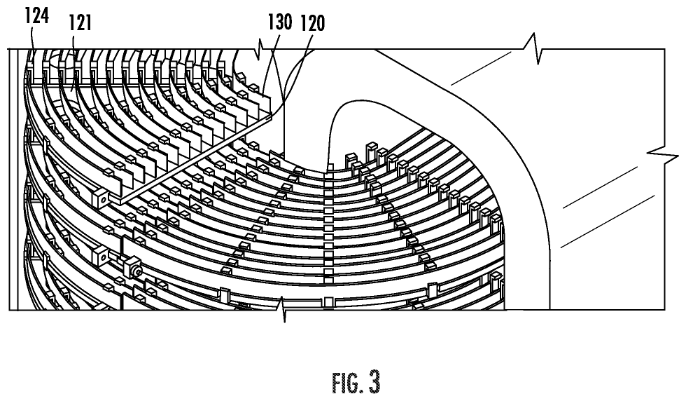

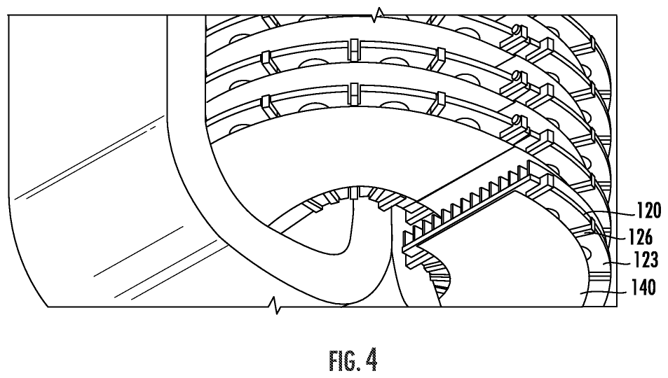

FIGS. 1-4 are perspective views of an inductive apparatus according to some embodiments. In particular, these figures show a transformer 100 including a toroidal core 110. A helical frame 120 surrounds a linear section 110a of the core 110 and supports first and second windings 130, 140. The helical frame 120 has first and second major surfaces 121, 123 on opposite sides of the frame 120. The first and second major surfaces 121, 123 are arranged generally normal to a surface of the core 110.

The first winding 130, here shown as comprising concentric ribbon-like conductors retained in a spaced apart manner using retainer members 124 extending from the first surface 121, conforms to the first surface 121 of the helical frame 120. The ribbon conductors of the first winding 130 have major surfaces generally normal to the first surface 121 and parallel to the axis of the core 110. The second winding 130 is shown as a single flat ribbon-like conductor having major surfaces generally normal to the axis of the core 110 and conforming to the second surface 123 of the helical frame 120. The second winding 140 is retained by retaining members 126 extending from the second major surface 123 of the helical frame 120.

The first winding 130, e.g., a low current winding, is held in a position normal to the second winding 140, e.g., a high-current winding. The helical frame 120 may be fabricated using, for example, 3-D printing techniques. This can allow for efficient fabrication of helical frames having various pitches and providing various incline angles for the windings 130, 140 in relation to the axis and/or surface of the core 110. As explained below, the frame 120 may be constructed in modular fashion the can support a variety of different coil arrangements.

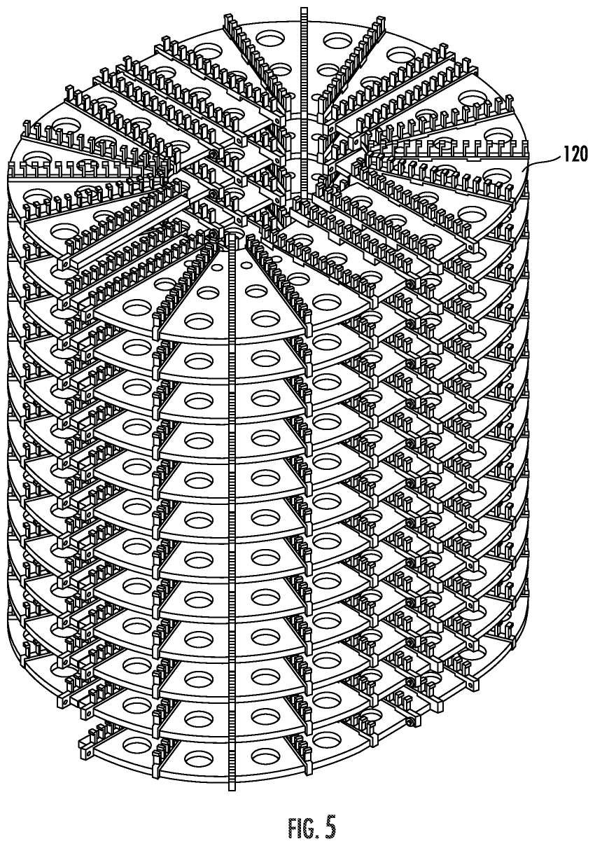

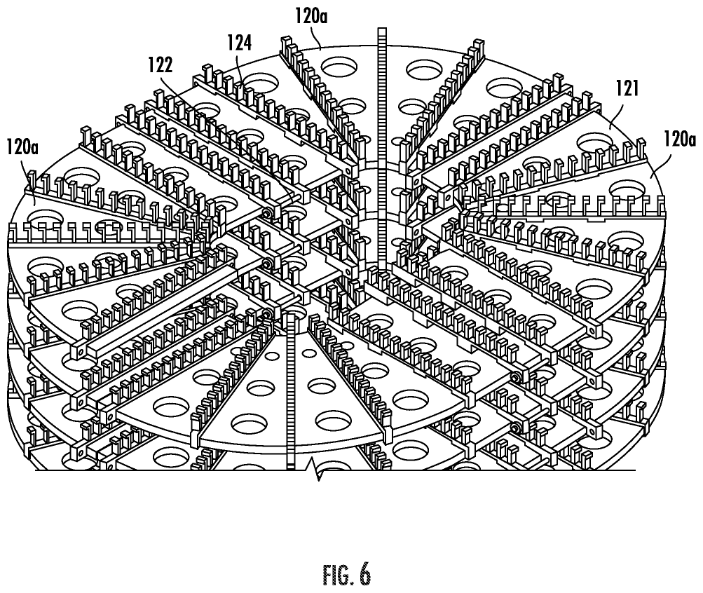

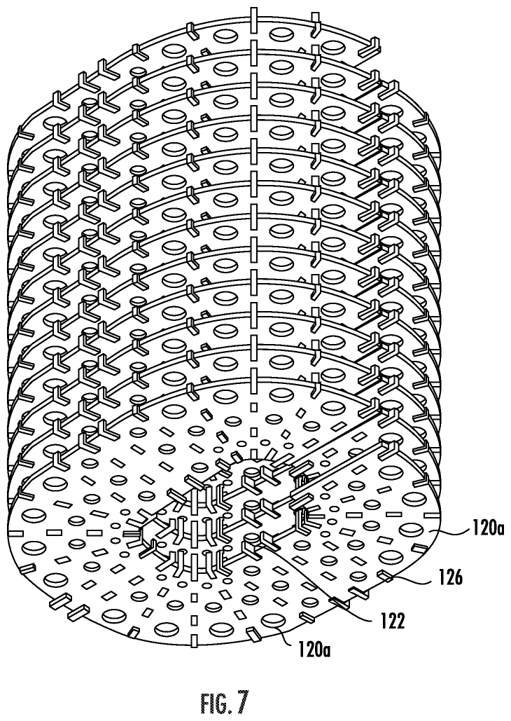

FIGS. 5-7 illustrate the frame 120 with the windings 130, 140 removed. As shown in FIG. 6, the frame 120 may be constructed from modular sections 120a, here shown as joined together using bolts 122. This modular structure allows helical frames with various numbers of turns to be fabricated to suit various applications. While the sections 120a illustrated are quarter-turn sections, it will be appreciated that other types of modular sections may be used (e.g., half- or full-turn sections). It will be further appreciated that such sections may be joined in various other ways to form a helical frame.

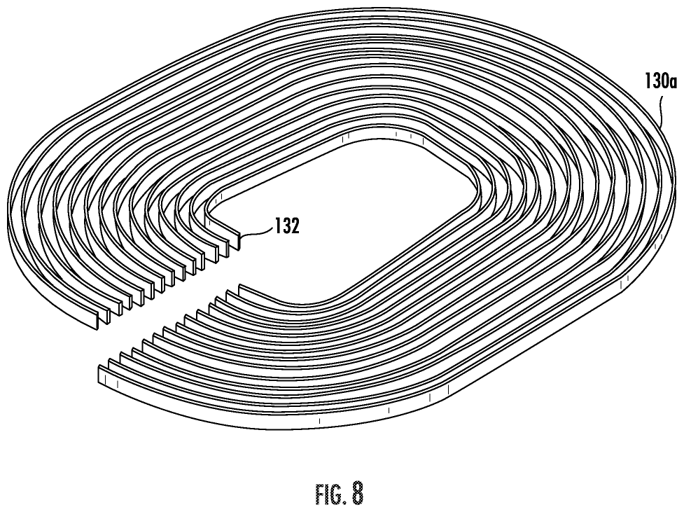

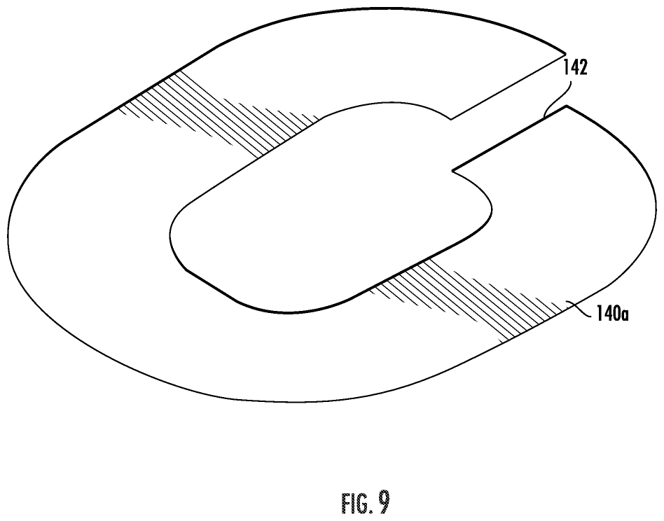

FIG. 8 illustrates a modular section 130a of the first winding 130. Various numbers of such sections 130a may be joined (e.g., soldered, welded, brazed, or otherwise electrically and mechanically connected) to one another at their ends 132 produce windings with various numbers of turns. In some embodiments, the ends 132 of terminal ones of the sections 130a, may be selectively joined to one another to produce windings with various numbers of turns. FIG. 9 illustrates a modular section 140a of the second winding 140. Various numbers of such sections 140a may be joined to one another at their ends 142 to produce windings with various numbers of turns. This modular approach involves using discrete parts that are adaptable to relatively simple additive manufacturing systems. It will be understood that some embodiments may be implemented using advanced 3-D printing techniques that involve printing components such as the helical frame 120 and the windings 130, 140.

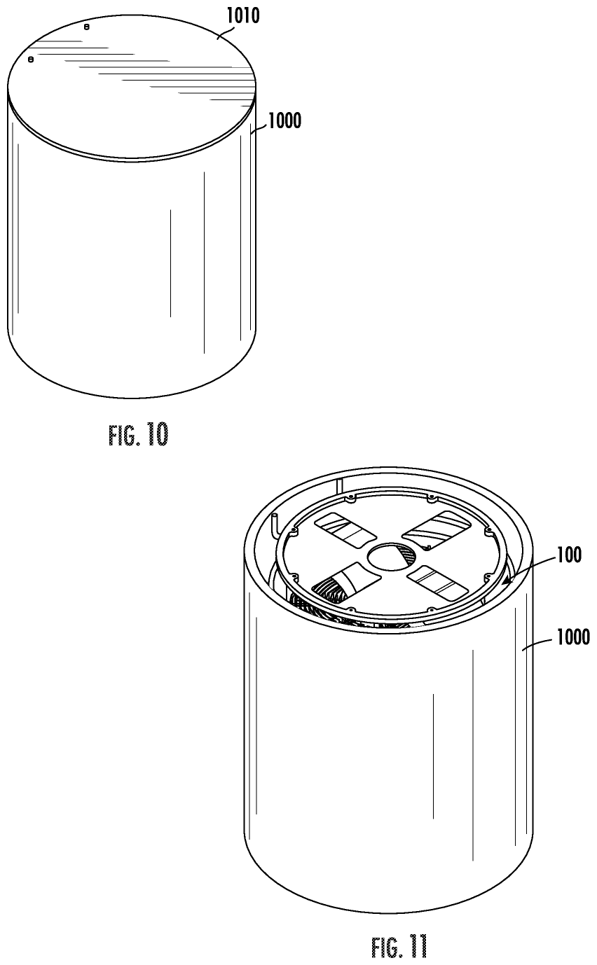

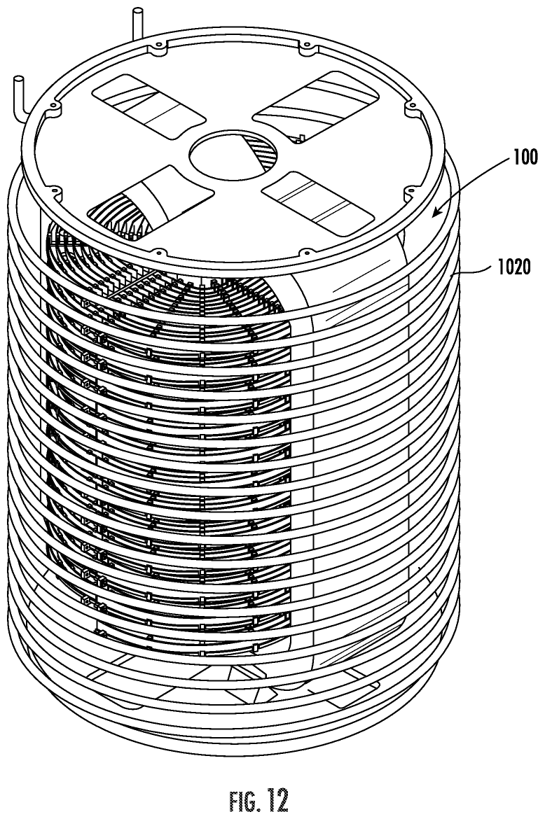

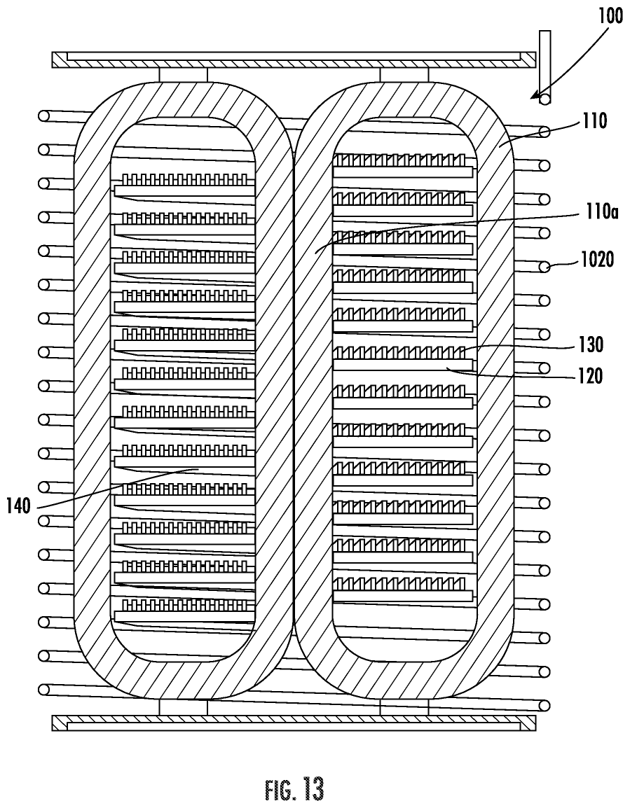

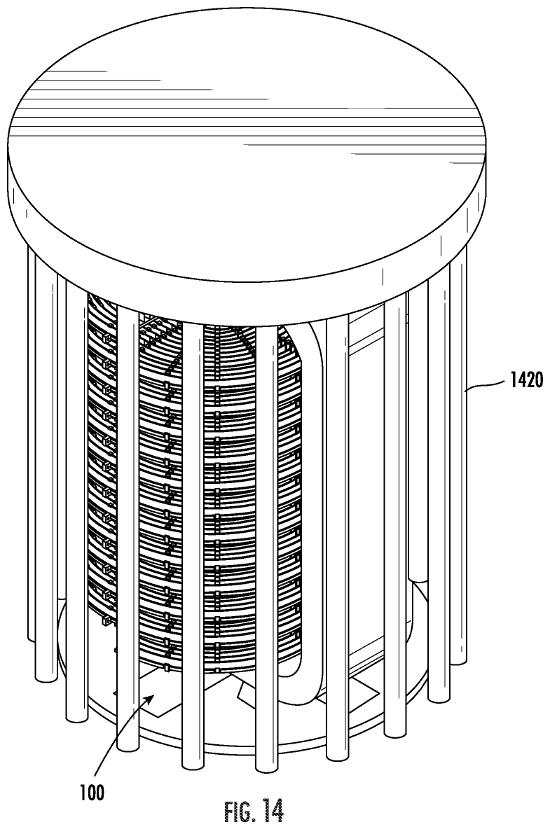

In some embodiments, inductive apparatus along the lines described above may be housed in an enclosure that can provide EMI shielding, support encapsulation in dielectric material and/or support structures for cooling the apparatus. Referring to FIGS. 10-13, the transformer apparatus 100 of FIGS. 1-4 may be encased in a cylindrical enclosure 1000 that is sealed by a top cover 1010. The enclosure 1000 may be filled with a high dielectric material, such as a high dielectric fluid, gas or powder, to increase isolation between the components of the transformer from one another and surrounding structures. The filling material may also be a thermally conductive material, such as diamond dust or ceramic powder, configured to convey heat away from the transformer 100 and to, for example, a spiral or serpentine cooling conduit 1020 surrounding the transformer 100 within the enclosure 1000. The cooling conduit 1020 may be configured to convey a cooling fluid from a source external to the enclosure 1000 to carry heat away from the interior of the enclosure 1000. FIG. 14 shows an alternative arrangement in which an array of peripheral cooling fluid conduits 1420 (e.g., heat pipes) surrounds the transformer 100 and acts to carry heat away from a transformer 100 to a radiator or other heat dissipation structure.

It will be appreciated that the inductive apparatus illustrated in FIGS. 1-14 is provided for purposes of illustration of example embodiments, and that other embodiments may take various other forms within the scope of the inventive subject matter. For example, other embodiments may incorporate only one winding (e.g., only one of the windings 130, 140 illustrated) for use as an inductor. Other embodiments may use different core structures, e.g., rather than the oval toroidal core illustrated, a circular or elliptical toroidal core may be used. Some embodiments may include a helical frame and coil(s) that completely or partially surrounds such a circular or elliptical toroidal core.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. An apparatus comprising:
a core;
a helical frame coaxial with a segment of the core and having first and second major surfaces on opposite sides of the helical frame and each normal to a surface of the segment; and
at least one helical coil conforming to at least one of the first and second major surfaces.

2. The apparatus of claim 1, wherein the at least one helical coil comprises a helical ribbon conductor having a major surface disposed parallel to one of the first and second major surfaces.

3. The apparatus of claim 1, wherein the at least one helical coil comprises a plurality of concentric helical coils disposed parallel to one of the first and second major surfaces.

4. The apparatus of claim 3, wherein the concentric helical coils comprise concentric ribbon conductors having major surfaces arrayed in a plane normal to the one of the first and second major surfaces.

5. The apparatus of claim 1, wherein the at least one helical coil comprises first and second helical coils conforming to respective ones of the first and second major surfaces.

6. The apparatus of claim 5, wherein the first helical coil comprises a helical ribbon conductor having a major surface disposed parallel to the first major surface of the helical frame.

7. The apparatus of claim 5, wherein the second helical coil comprises a plurality of concentric helical coils arrayed parallel to the second major surface of the helical frame.

8. The apparatus of claim 7, wherein the concentric helical coils comprise concentric ribbon conductors having major surfaces disposed normal to the second major surface of the helical frame.

9. The apparatus of claim 1, wherein the helical frame comprises a plurality of interconnected modular segments.

10. The apparatus of claim 1, wherein the segment of the core is linear.

11. An apparatus comprising:
a toroidal core comprising a linear segment;
a helical frame coaxial with the linear segment and having first and second major surfaces on opposite sides of the helical frame and each normal to a surface of the linear segment of the toroidal core; and
first and second helical coils conforming to respective ones of the first and second major surfaces of the helical frame.

12. The apparatus of claim 11, wherein the first helical coil comprises a helical ribbon conductor having a major surface disposed parallel to the first major surface of the helical frame and wherein the second helical coil comprises a plurality of concentric helical coils arrayed parallel to the second major surface of the helical frame.

13. The apparatus of claim 12, wherein the concentric helical coils comprise concentric ribbon conductors having major surfaces disposed normal to the second major surface of the helical frame.

14. The apparatus of claim 11, wherein the helical frame comprises a plurality of interconnected modular segments.

15. The apparatus of claim 11, further comprising an enclosure containing the toroidal core, the helical frame and the first and second helical coils therein.

16. The apparatus of claim 15, wherein the enclosure is filled with a dielectric material.

17. The apparatus of claim 16, further comprising a conduit disposed in the enclosure, surrounding the toroidal core, the helical frame and the first and second helical coils, and configured to circulate a cooling fluid.

18. A transformer comprising:
a core comprising a linear segment;
a helical frame coaxial with the linear segment and having first and second major surfaces on opposite sides of the helical frame and each normal to the linear segment;
a first helical coil conforming to the first major surface; and
a second helical coil conforming to the second major surface.

19. The transformer of claim 18, wherein the first helical coil comprises a helical ribbon conductor having a major surface disposed parallel to the first major surface and wherein the second helical coil comprises a plurality of concentric coils arrayed parallel to the second major surface.

20. The transformer of claim 19, further comprising:
an enclosure containing the core, the helical frame and the first and second helical coils therein; and
a conduit disposed in the enclosure, surrounding the core, the helical frame and the first and second helical coils, and configured to circulate a cooling fluid.
